(19) United States
(12) Patent Application Publication
(10) Pub. No.: US 2007/0274274 A1
(43) Pub. Date: Nov. 29, 2007

(54) Open wireless access point detection and identification

(76) Inventor: Matthew E. Carothers, Atlanta, GA (US)

Correspondence Address: Merchant & Gould, P.C., P.O. Box 2903, Minneapolis, MN, 55402-0903, US

(21) Appl. No.: 11/439,801

(22) Filed: May 24, 2006

(51) Int. Cl. H04Q 7/24; H04L 12/56

(52) U.S. Cl. 370/338; 370/395.2

(57) ABSTRACT

Automatically identifying a user of an open wireless access point in a communications network may be provided. A wireless signal may be transmitted to detect the status of a wireless network connected to a wireless access point. If the status of the wireless network connection is open, then a connection may be automatically established with the wireless access point over the open wireless network connection. The open wireless connection may then be used to automatically send data over the communications network to determine the identity of a user of the wireless access point.

### BACKGROUND

Wireless (Wi-Fi) networks use high-frequency radio waves instead of wires to connect to computer networks, such as the Internet. Typically, a Wi-Fi network includes a modem for establishing a connection to the Internet and a wireless access point (WAP) that establishes a wireless connection between the Internet and a computer equipped with a wireless adapter. For example, subscribers having accounts with an Internet service provider (ISP) may use their own Wi-Fi networks to connect to the Internet using an Internet protocol (IP) address assigned by the ISP.

Since WAPs utilize radio waves for communication, they may be accessed by anyone equipped with a computer and a wireless adapter within range (e.g., 300 feet) of the radio waves. As a result, WAPs typically include optional encryption, which when enabled, requires a user-specified password or key for access to the Wi-Fi network. WAPs that do not have the optional encryption enabled (i.e., “open” WAPs) are subject to being accessed by unauthorized users who may illegally access a subscriber's ISP account connect to the Internet. Moreover, many of these unauthorized users may use a subscriber's ISP account to engage in various abusive activities over the Internet such as spamming, phishing, hacking, and credit card fraud without the subscriber ever knowing such activities took place. This is particularly a problem for ISPs having subscribers in high-density living environments such as apartment complexes and college dormitories where there may be a considerable number of computer users within range of a single open WAP.

In recent years, open source software has been developed to enable the detection of open WAPs. Unfortunately, the software does not facilitate the identification of the owner of a WAP or the network to which the WAP is connected because WAPs utilize network address translation to broadcast IP addresses that are different from the IP addresses assigned by ISPs to subscribers. Therefore, ISPs are unable to determine if the owner of an open WAP is a subscriber using the aforementioned open source software and thus are unable to prevent the unauthorized use of subscriber accounts.

### BRIEF SUMMARY

Open wireless access point detection and identification may be provided. This Summary is provided to introduce a selection of concepts in a simplified form that are further described below in the Detailed Description. This Summary is not intended to identify key features or essential features of the claimed subject matter. Nor is this Summary intended to be used to limit the scope of the claimed subject matter. Automatically identifying a user of an open wireless access point in a communications network may be provided.

A wireless signal may be transmitted to detect the status of a wireless network connected to a wireless access point. If the status of the wireless network connection is open, then a connection may be automatically established with the wireless access point over the open wireless network connection. The open wireless connection may then be used to automatically send data over the communications network to determine the identity of a user of the wireless access point

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE SEVERAL VIEWS OF THE DRAWINGS

FIG. 1 is a network diagram illustrating aspects of several computer systems;

FIG. 2 is a computer system architecture diagram illustrating aspects of a client computer system;

FIG. 3 is a flow diagram illustrating a process for automatically identifying a user of an open wireless access point; and

FIG. 4 is a flow diagram illustrating a process for automatically identifying a user of an open wireless access point.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Generally, program modules include routines, programs, components, data structures, and other types of structures that perform particular tasks or implement particular abstract data types. Moreover, the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

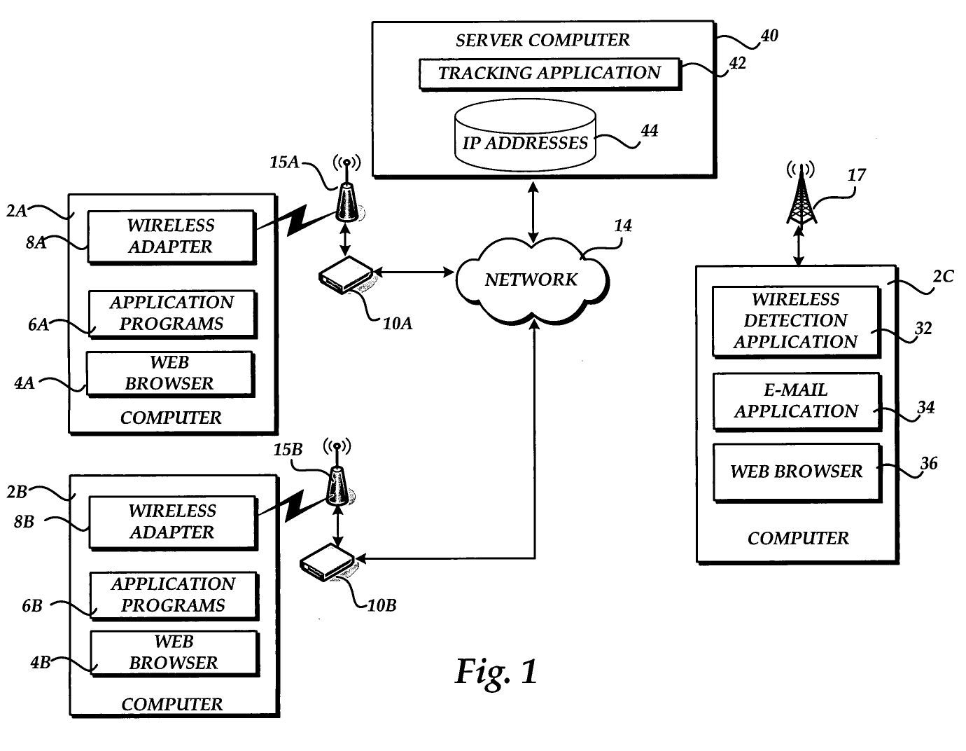

Referring now to FIG. 1, an illustrative operating environment for the several embodiments of the invention will be described. As shown in FIG. 1, a network 14 interconnects computers 2A, 2B, and server computer 40. The illustrative operating environment also includes computer 2C that is capable of wireless communication with the computers 2A and 2C, as described in greater detail below. Network 14 may comprise a wide area computing network, such as the Internet. Network 14 may provide a medium for enabling communication between computers 2A-2B, server computer 40, and potentially other computer systems connected to or accessible through network 14.

Consistent with an embodiment of the invention, access to network 14 by computers 2A-2B and server computer 40 may be provided by a cable television services network. Such networks may provide digital and analog video programming, telephone services, high speed Internet access, video-on-demand, and information services to customers via a hybrid fiber coax (HFC) network consisting of both optical fiber and coaxial cable lines. Network (e.g., Internet) access may be provided by connecting cable modems (such as cable modems 10A and 10B) to incoming coaxial cable lines at a customer premises. When providing Internet access, the cable television services network may serve as an Internet service provider (ISP) enabling customers to engage in a variety of online activities including browsing the World Wide Web and sending and receiving e-mail for a fee. The ISP may assign each customer an IP address that may be used to identify the customer for billing and other purposes as well as to track network usage.

Computers 2A-2B may comprise general-purpose desktop or laptop client computer systems capable of executing web browsers 4A and 4B for browsing the World Wide Web. Computers 2A-2B may also be operative to execute application programs 6A and 6B that may be used, for example, to send and receive e-mail messages over network 14. Computers 2A and 2B may further comprise wireless adapters 8A and 8B that may be used to communicate with WAPs 15A and 15B, respectively. Wireless adapters 8A and 8B and WAPs 15A and 15B may comprise a wireless local area network (WLAN). Wireless adapters 8A and 8B may be antennas that may be internal or external components of computers 2A and 2B. For instance, in one embodiment, wireless adapters 8A and 8B may be one or more integrated wireless antennas within computers 2A and 2B. In another embodiment, wireless adapters 8A and 8B may be externally connected to computers 2A and 2B via an input/output controller (not shown).

Through WAPs 15A and 15B, computers 2A and 2B may establish wireless connections with network 14 (through modems 10A and 10B), with each other, or with other computers for communicating data within the wireless range defined by various WLAN standards. In accordance with embodiments of the invention, the WLAN standards may include with the 802.11 family of specifications developed by the Institute of Electrical and Electronics Engineers for wireless LAN technology that specifies an over-the-air interface between a wireless client and a base station (e.g., a WAP) or between two wireless clients.

In establishing a connection for communicating data over network 14, WAPs 15A and 15B may use network address translation (NAT). NAT is a standard that may enable a WLAN to use one set of Internet protocol (IP) addresses for internal traffic (i.e., data communications between a computer and the WAP) and a second set of addresses for external traffic (i.e., data communications between the WAP and the Internet). In a typical WLAN, the WAP may assign all connected computers a reserved pool of internal IP address that may be then translated to one or more external IP addresses (that are assigned by the ISP) when data is communicated over the Internet.

A WAP may assign the pool of internal IP addresses using Dynamic Host Configuration Protocol (DHCP). DHCP is a protocol for assigning dynamic IP addresses to devices on a network. With dynamic addressing, a computer can have a different IP address every time it connects to the network. In particular, IP addresses may be assigned using a “request-and-grant” process in which the computer's networking software (e.g., TCP/IP) may be configured to lease an IP address from a WAP (acting as a DHCP server) for a predetermined time period.

Computer 2C may comprise a general-purpose desktop or laptop client computer system capable of wireless communication with computers 2A-2B via connected antenna 17. Computer 2C may also be also operative to execute wireless detection application 32, e-mail application 34, and web browser 36. According to an embodiment of the invention, wireless detection application 32 may be utilized to automatically detect open WAPs (i.e., unsecured WAPs) within the range of antenna 17 that are in communication with network 14. WAPs may be configured for secured access through the use of a user-generated network key or passphrase. The network key or password may be generated according to a wireless security protocol that is used to encrypt data communicated over wireless networks. Common wireless security protocols may include Wired Equivalent Privacy (WEP) and Wi-Fi Protected Access (WPA). Secured WAPs may require the network key or passphrase for connecting to wireless networks. Unsecured WAPs do not require the network key or passphrase and are known as “open.”

As described in greater detail below, wireless detection application 32 may also be utilized to automatically establish a connection with any detected open WAPs and automatically utilize the open WAPs to generate and send data traffic (e.g., an e-mail message using e-mail application 34 or navigating to a website using web browser 36) over network 14 to server computer 40. As described in greater detail below, the data traffic may be parsed for an external IP address to identify the owner of an open WAP.

Server computer 40 may be operative to execute a tracking application 42. According to an embodiment, tracking application 42 may be utilized to parse the data traffic received from computer 2C for the IP addresses of users having open WAPs. The tracking application 42 may be further utilized to compare the external IP addresses from the parsed data traffic to IP addresses stored in database 44 to determine if any of the external IP addresses match any of the stored IP addresses.

Computer 2C may be a vehicle based computer system operated by an ISP that patrols densely populated customer areas (e.g., apartment complexes) to detect open WAPs. Server computer 40 may be a component in an abuse tracking system for the ISP. IP addresses received by server computer 40 may be compared to IP addresses assigned by the ISP to determine customers with open WAPs. Once these customers are identified, the ISP may then send each customer a communication reminding them to utilize available encryption features on their WAP to protect against unauthorized use.

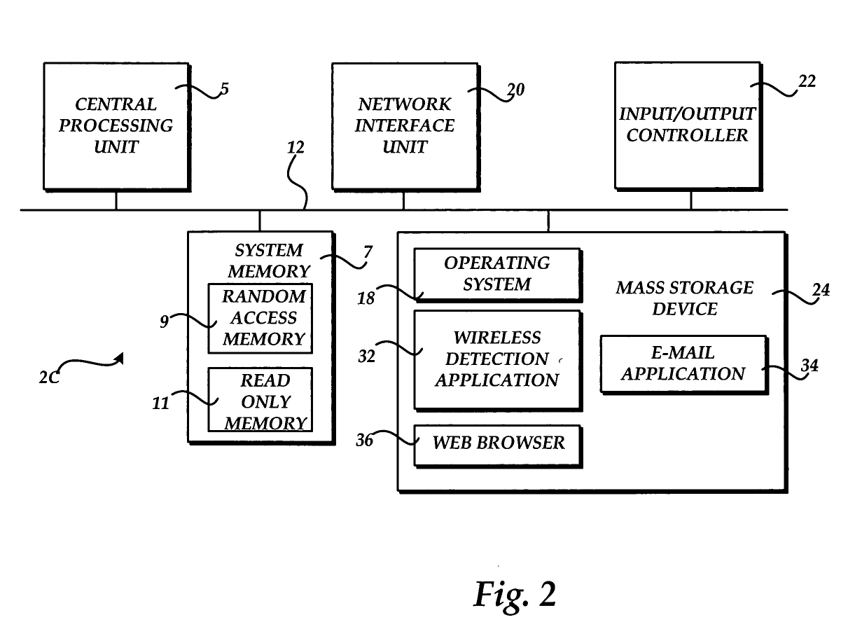

Referring now to FIG. 2, a computer architecture for computer 2C utilized in embodiments of the invention is described. The computer architecture shown in FIG. 2C illustrates a conventional desktop or laptop computer, including a central processing unit 5 (CPU), a system memory 7, including a random access memory 9 (RAM) and a read-only memory (ROM) 11, and a system bus 12 that couples the memory to CPU 5. A basic input/output system containing the basic routines that help to transfer information between elements within the computer, such as during startup, is stored in ROM 11. Computer 2C may further include a mass storage device 24 for storing an operating system 18, wireless detection application 32, e-mail application 34, and web browser 36. Computer 2C may also include other application programs and program modules not described.

Mass storage device 24 may be connected to CPU 5 through a mass storage controller (not shown) connected to bus 12. Mass storage device 24 and its associated computer-readable media provide non-volatile storage for computer 2C. Although the description of computer-readable media contained herein refers to a mass storage device, such as a hard disk or CD-ROM drive, computer-readable media can be any available media that can be accessed by computer 2C.

By way of example, and not limitation, computer-readable media may comprise computer storage media and communication media. Computer storage media may include volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and that can be accessed by computer 2C.

According embodiments of the invention, computer 2C may operate in a networked environment using logical connections to remote computers through one or more wireless networks. Computer 2C may connect to the wireless networks through an antenna (i.e., the antenna 17 of FIG. 1) connected to network interface unit 20 that may be connected to the bus 12. Network interface unit 20 may also be utilized to connect to other types of networks and remote computer systems. Computer 2 may also include an input/output controller 22 for receiving and processing input from a number of other devices, including a keyboard, mouse, or electronic stylus (not shown in FIG. 2). Similarly, an inpuVoutput controller 22 may provide output to a display screen, a printer, or other type of output device.

Mass storage device 24 and RAM 9 may also store one or more program modules. In particular, mass storage device 24 and RAM 9 may store wireless detection application 32, e-mail application 34, and web browser 36, as described above with respect to FIG. 1. Computers 2A-2B and server computer 40 may include many of the computing components illustrated in FIG. 2 and described above. Computers 2A-2B and server computer 40 may also include other components not illustrated in FIG. 2.

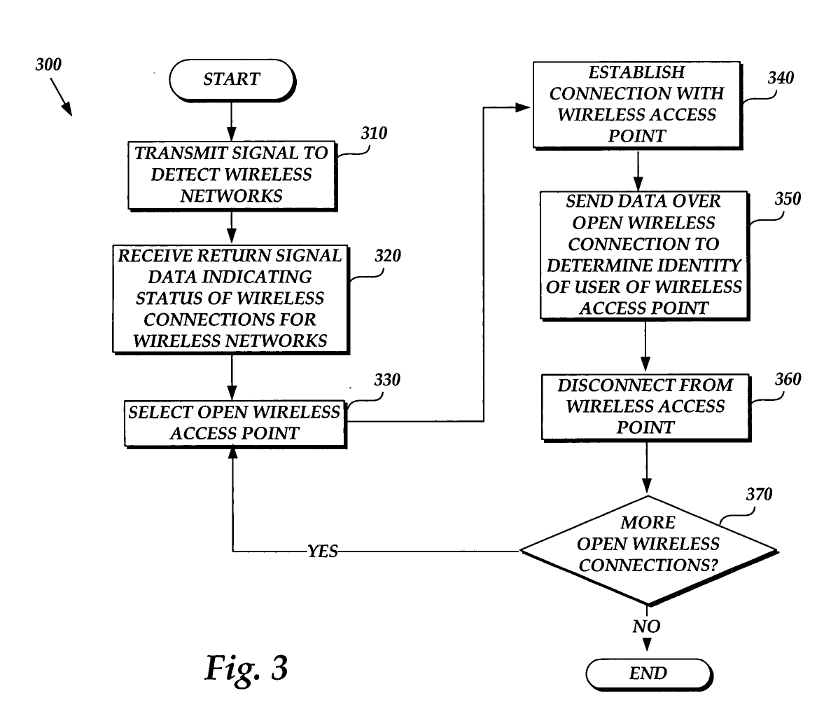

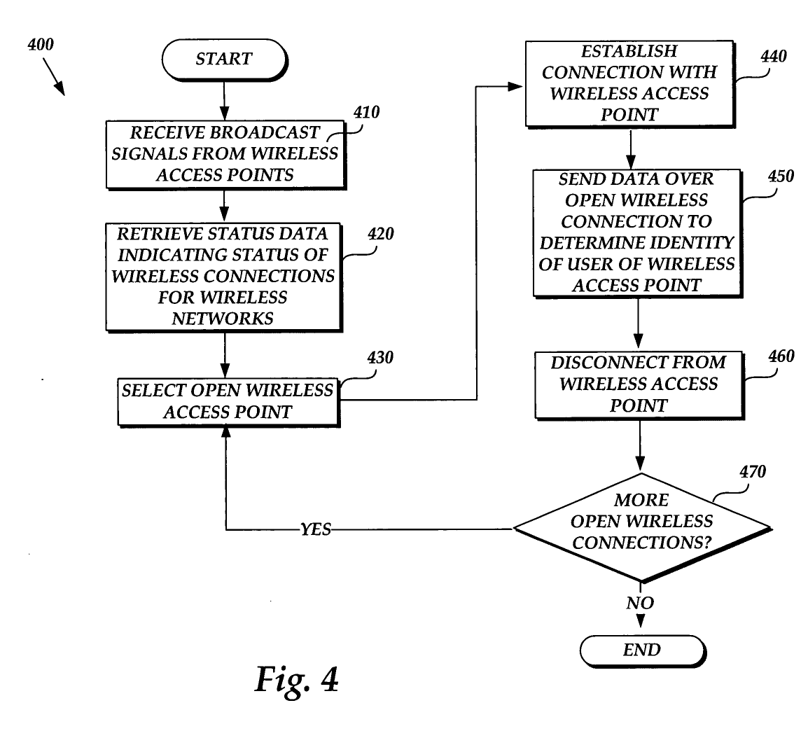

Referring now to FIGS. 3-4, routines will be described illustrating a process performed by the execution of wireless detection application 32 on computer 2C for automatically identifying a user of an open WAP. When reading the discussion of the routines presented herein, the logical operations of various embodiments of the present invention may be implemented (1) as a sequence of computer implemented acts or program modules running on a computing system and/or (2) as interconnected machine logic circuits or circuit modules within the computing system. The implementation may be a matter of choice dependent on the performance requirements of the computing system implementing the invention. Accordingly, the logical operations illustrated in FIGS. 3-4, and making up embodiments of the present invention described herein, may be referred to variously as operations, structural devices, acts or modules. These operations, structural devices, acts and modules may be implemented in software, in firmware, in special purpose digital logic, and any combination thereof without deviating from the spirit and scope of the present invention as recited within the claims set forth herein.

Referring now to FIG. 3, routine 300 may begins at operation 310, where a user may execute, on computer 2C, wireless detection application 32 that may instruct antenna 17 to transmit a wireless signal for detecting any wireless computer networks within range which are connected to WAPs. Routine 300 then continues from operation 310 at operation 320, where wireless detection application 32 receives data via one or more return signals received by the antenna 17 that identifies any detected wireless networks and indicates the status of each wireless network connection to a WAP. In particular, after transmitting the signal to detect wireless networks, wireless detection application 32 instructs antenna 17 to listen for data packets (e.g., 802.11b/g beacon packets) from open WAPs. The data received by wireless detection application 32 indicates an identification associated with the wireless network (i.e., a service set identifier or SSID) and whether or not a detected wireless network connection is secured by a wireless security protocol. As discussed above, wireless networks that are not secured by a wireless security protocol represent open WAPs.

Routine 300 may continue from operation 320 at operation 330 where wireless detection application 32 selects an open WAP from the detected unsecured wireless networks. In particular, if multiple wireless networks are detected by wireless detection application 32, unsecured wireless networks representing open WAPs may be individually selected in alphabetical or numerical order while secured wireless networks are ignored.

Routine 300 may continue from operation 330 at operation 340 where wireless detection application 32 establishes a wireless connection with the selected WAP. In particular, wireless detection application 32 may automatically request a DHCP lease from the selected WAP to receive an internal IP address for establishing a connection to the selected WAP.

Routine 300 then continues from operation 340 at operation 350 where wireless detection application 32 automatically sends data over the wireless connection established with the selected WAP through network 14 to determine the identify of a user of the WAP. In particular, wireless detection application 32 may generate and send Internet data traffic which is parsed by tracking application 42 to retrieve an external IP address to the server 40. As discussed above with respect to FIG. 1, tracking application 42 on server 40 may be utilized to compare the external IP address to IP addresses in IP addresses database 44 to identify a user of the WAP. For instance, according to an embodiment, wireless detection application 32 utilizes the selected WAP to generate and send an e-mail message over the Internet (using the e-mail application 34) to an e-mail address associated with server 40. Tracking application 42 may be configured to monitor incoming e-mail messages sent to the e-mail address associated with server 40. Once the e-mail message is received, tracking application 42 parses the message header for routing information. This routing information includes an external IP address (a source address) and one or more destination IP addresses that indicate the path the e-mail message took as it traveled to its destination. The external IP address in the received e-mail message header represents the network (e.g., ISP) assigned IP address for the user of the WAP used to send the message.

In another embodiment of the invention, the Internet data traffic sent to server 40 may also be generated as a result of wireless detection application 32 being configured to automatically connect with an open WAP to navigate to Uniform Resource Locator (URL) for a website hosted by server 40. In this embodiment, tracking application 42 may be configured to monitor requests for the website and retrieve the external or source IP address from received request data. The external IP address in the received request data represents the network (e.g., ISP) assigned IP address for the owner of the WAP used to navigate to the URL. It will be appreciated that the URL may be designated to only be used upon detecting an open WAP. Other types of Internet data traffic may also be received by server 40 for determining an external or source IP address identifying a user of an open WAP including, but not limited to, User Datagram Protocol (UDP) data and data packets, such as those used to troubleshoot Internet connections (e.g., “Ping”), etc.

Routine 300 continues from operation 350 at operation 360 where wireless detection application 32, after sending the data to the server 40, automatically disconnects from the currently selected open WAP. Routine 300 then continues from operation 360 at operation 370 where the wireless detection application 32 determines if there are any additional detected open WAPs. If there are additional open WAPs, routine 300 returns to operation 330 where the next open WAP may be selected. If there are no additional open WAPs, routine 300 then ends.

Referring not to FIG. 4, routine 400 begins at operation 410, where a user executes, on computer 2C, wireless detection application 32 which instructs antenna 17 to receive broadcast signals from WAPs within range by passively listening for them. Routine 400 then continues from operation 410 at operation 420, where wireless detection application 32 receives status data in the received broadcast signals indicating the status of wireless connections to the WAPs within range.

Routine 400 may continue from operation 420 at operation 430 where wireless detection application 32 selects an open WAP from any unsecured wireless networks as discussed above with respect to FIG. 3. Routine 400 continues from operation 430 at operation 440 where wireless detection application 32 establishes a wireless connection with the selected WAP as discussed above with respect to FIG. 3.

Routine 400 then continues from operation 440 at operation 450 where wireless detection application 32 automatically sends data over the wireless connection established with the selected WAP through network 14 to determine the identify of a user of the WAP as discussed above with respect to FIG. 3. Routine 400 continues from operation 450 at operation 460 where the wireless detection application 32, after sending the data to server 40, automatically disconnects from the currently selected open WAP. Routine 400 then continues from operation 460 at operation 470 the wireless detection application 32 determines if there are any additional detected open WAPs. If there are additional open WAPs, routine 400 returns to operation 430 where the next open WAP is selected. If there are no additional open WAPs, the routine 400 then ends.

Based on the foregoing, the various embodiments of the invention include methods and computer-readable media for automatically identifying a user of an open wireless access point in a communications network. The methods and computer-readable media enable a data services provider, such as an ISP, to detect customers with open wireless access points which may be exploited by unauthorized users to access the communications network.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of automatically identifying a user of an open wireless access point in a communications network, comprising:
receiving status data indicating a status of a wireless network connection to a wireless access point in the communications network; and
if the status of the wireless network connection is open, then:
automatically establishing a connection with the wireless access point over the open wireless network connection; and
automatically utilizing the open wireless connection to send data over the communications network to determine the identity of a user of the wireless access point.

2. The method of claim 1 further comprising:
transmitting a wireless signal to detect a wireless network, wherein the wireless network is connected to the wireless access point; and
in response to the transmitted wireless signal, receiving a return signal wherein the return signal includes the status data indicating the status of the wireless network connection to the wireless access point.

3. The method of claim 1 further comprising:
receiving a broadcast signal from the wireless access point; and
retrieving the status data indicating the status of the wireless network connection to the wireless access point from the broadcast signal.

4. The method of claim 1, wherein automatically establishing a connection with the wireless access point over the open wireless network connection comprises:
associating with the wireless access point; and
receiving an identifier assigned by the wireless access point;

5. The method of claim 4, wherein receiving an identifier assigned by the wireless access point comprises:
requesting a Dynamic Host Control Protocol lease from the wireless access point; and
receiving an internal Internet Protocol address in response to the request.

6. The method of claim 5, wherein automatically utilizing the open wireless connection to send data over the communications network to determine the identity of a user of the wireless access point comprises using the internal Internet Protocol address to send Internet traffic from the wireless access point over the open wireless connection through the communications network, wherein the identity of the user of the wireless access point is determined from the Internet traffic after the Internet traffic is received from the wireless access point.

7. The method of claim 6, wherein using the Internet Protocol address to send Internet traffic from the wireless access point over the open wireless connection through the communications network comprises sending a Uniform Resource Locator for connecting to a Web site over the open wireless connection.

8. The method of claim 6, wherein using the Internet Protocol address to send Internet traffic from the wireless access point over the open wireless connection through the communications network comprises sending an electronic mail message over the open wireless connection.

9. The method of claim 1, wherein transmitting a wireless signal to detect a wireless network comprises transmitting a wireless signal to detect a plurality of wireless networks connected to a plurality of wireless access points within a predetermined geographic area.

10. The method of claim 9, wherein automatically establishing a connection with the wireless access point over the open wireless network connection comprises selectively establishing a connection with each of the plurality of wireless access points over each of a plurality of open wireless connections.

11. The method of claim 1, wherein automatically utilizing the open wireless connection to send data over the communications network to determine the identity of a user of the wireless access point comprises utilizing the open wireless connection to send data over a cable services network.

12. The method of claim 1 further comprising automatically disconnecting from the wireless access point.

13. A computer-readable medium having computer-executable instructions which, when executed on a computer, cause the computer to perform a method of automatically identifying a user of an open wireless access point in a communications network, the method comprising:
receiving status data indicating a status of a wireless network connection to a wireless access point in the communications network; and
if the status of the wireless network connection is open, then:
automatically establishing a connection with the wireless access point over the open wireless network connection; and
automatically utilizing the open wireless connection to send data over the communications network to determine the identity of a user of the wireless access point.

14. The computer-readable medium of claim 13 further comprising:
transmitting a wireless signal to detect a wireless network, wherein the wireless network is connected to the wireless access point; and
in response to the transmitted wireless signal, receiving a return signal wherein the return signal includes the status data indicating the status of the wireless network connection to the wireless access point.

15. The computer-readable medium of claim 13 further comprising:
receiving a broadcast signal from the wireless access point; and
retrieving the status data indicating the status of the wireless network connection to the wireless access point from the broadcast signal.

16. The computer-readable medium of claim 13, wherein automatically establishing a connection with the wireless access point over the open wireless network connection comprises:
associating with the wireless access point; and
receiving an identifier assigned by the wireless access point;

17. The computer-readable medium of claim 16, wherein receiving an identifier assigned by the wireless access point comprises:
requesting a Dynamic Host Control Protocol lease from the wireless access point; and
receiving an internal Internet Protocol address in response to the request.

18. The computer-readable medium of claim 17, wherein automatically utilizing the open wireless connection to send data over the communications network to determine the identity of a user of the wireless access point comprises using the internal Internet Protocol address to send Internet traffic from the wireless access point over the open wireless connection through the communications network, wherein the identity of the user of the wireless access point is determined from the Internet traffic after the Internet traffic is received from the wireless access point.

19. The computer-readable medium of claim 18, wherein using the Internet Protocol address to send Internet traffic from the wireless access point over the open wireless connection through the communications network comprises sending a Uniform Resource Locator for connecting to a Web site over the open wireless connection.

20. The computer-readable medium of claim 18, wherein using the Internet Protocol address to send Internet traffic from the wireless access point over the open wireless connection through the communications network comprises sending an electronic mail message over the open wireless connection.

21. The computer-readable medium of claim 13, wherein transmitting a wireless signal to detect a wireless network comprises transmitting a wireless signal to detect a plurality of wireless networks connected to a plurality of wireless access points within a predetermined geographic area.

22. The computer-readable medium of claim 21, wherein automatically establishing a connection with the wireless access point over the open wireless network connection comprises selectively establishing a connection with each of the plurality of wireless access points over each of a plurality of open wireless connections.

23. The computer-readable medium of claim 13, wherein automatically utilizing the open wireless connection to send data over the communications network to determine the identity of a user of the wireless access point comprises utilizing the open wireless connection to send data over a cable services network.

24. The computer-readable medium of claim 13 further comprising automatically disconnecting from the wireless access point.
